(19) United States
(12) Patent Application Publication
(10) Pub. No.: US 2022/0276510 A1
(43) Pub. Date: Sep. 1, 2022

(54) LENS MODULE AND EYEGLASS MODULE COMPRISING SAME

(71) Applicant: RMK Inc., Sejong-si (KR)

(72) Inventor: Minki Ryu, Sejong-si (KR)

(21) Appl. No.: 17/664,029

(22) Filed: May 18, 2022

(30) Foreign Application Priority Data
Nov. 19, 2019 (KR) 10-2019-0148853

(51) Int. Cl. G02C 7/10

(52) U.S. Cl. CPC G02C 7/108; G02C 7/104; G02B 1/115

(57) ABSTRACT

A lens module includes a base member, a first hard coating layer, a filter, a first water-repellent layer, a second hard coating layer, a light absorption layer and a second water-repellent layer. The base member allows at least a portion of incident light to transmit and is dyed by a dye material. The first hard coating layer is disposed on the base member and include silicon dioxide. The filter is disposed on the first hard coating layer and has a light transmissivity of 10% or lower for wavelengths of 555 nm or greater and 565 nm or smaller of the incident light. The first water-repellent layer is disposed on the filter and includes a hydrophobic material. The second hard coating layer is disposed underneath the base member and includes silicon dioxide. The light absorption layer is disposed underneath the second hard coating layer, is configured to absorb at least a portion of the incident light, and includes silicon dioxide and zirconium oxide. The second water-repellent layer is disposed underneath the light absorption layer and includes a hydrophobic material.

### TECHNICAL FIELD

The present disclosure relates to a lens module including a filter for people with a color deficiency and a glasses module including the lens module.

### BACKGROUND

Specially coated lenses and eyeglasses for correcting color amblyopia have been developed for people with red-green color amblyopia.

By reflecting incident light between red light pulses and green light pulses and allowing the light having other pulses to be incident, red-green amblyopic people may readily distinguish the colors of red and green.

Nonetheless, while forming a filter for readily distinguishing red and green, the filter has been incapable of clearly distinguishing red and green, depending on the transmissivity and reflectivity of the filter.

Moreover, the light incident from the back of the person wearing the eyeglasses is often visible due to the reflectivity of the filter.

### SUMMARY

The present disclosure provides a lens module and a glasses module by which color red and color green may be clearly distinguished.

The present disclosure also provides a lens module and a glasses module with an improved visibility by preventing the light from being incident from the back of the person wearing the glasses.

A lens module in accordance with an embodiment of the present disclosure may include a base member, a first hard coating layer, a filter, a first water-repellent layer, a second hard coating layer, a light absorption layer and a second water-repellent layer. The base member may allow at least a portion of incident light to transmit and may be dyed by a dye material. The first hard coating layer may be disposed on the base member and may include silicon dioxide. The filter may be disposed on the first hard coating layer and may have a light transmissivity of 10% or lower for wavelengths of 555 nm or greater and 565 nm or smaller of the incident light. The first water-repellent layer may be disposed on the filter and may include a hydrophobic material. The second hard coating layer may be disposed underneath the base member and may include silicon dioxide. The light absorption layer may be disposed underneath the second hard coating layer and configured to absorb at least a portion of the incident light and may include silicon dioxide and zirconium oxide. The second water-repellent layer may be disposed underneath the light absorption layer and may include a hydrophobic material.

In an embodiment of the present disclosure, the base member may include synthetic resin.

In an embodiment of the present disclosure, the filter may include a plurality of low refractive index layer and a plurality of high refractive index layers. Each of the plurality of low refractive index layers may include silicon aluminum oxide. Each of the high refractive index layers may have a higher refractive index than a refractive index of each of the plurality of low refractive index layers and may include titanium oxide and may be disposed alternately with each of the low refractive index layers.

In an embodiment of the present disclosure, the number of the plurality of low refractive index layers may be greater than the number of the plurality of high refractive index layers.

In an embodiment of the present disclosure, the filter may include: a first functional layer disposed on the base member and having a refractive index higher than or equal to a first value and lower than or equal to a second value and including silicon aluminum oxide; a second functional layer disposed on the first functional layer and having a refractive index higher than or equal to a third value and lower than or equal to a fourth value and including titanium niobium oxide, the third value being greater than the second value; a third functional layer disposed on the second functional layer and having a refractive index higher than or equal to the first value and lower than or equal to the second value and including silicon aluminum oxide; a fourth functional layer disposed on the third functional layer and having a refractive index higher than or equal to the third value and lower than or equal to the fourth value and including titanium niobium oxide; a fifth functional layer disposed on the fourth functional layer and having a refractive index higher than or equal to the first value and lower than or equal to the second value and including silicon aluminum oxide; a sixth functional layer disposed on the fifth functional layer and having a refractive index higher than or equal to the third value and lower than or equal to the fourth value and including titanium niobium oxide; a seventh functional layer disposed on the sixth functional layer and having a refractive index higher than or equal to the first value and lower than or equal to the second value and including silicon aluminum oxide; an eighth functional layer disposed on the seventh functional layer and having a refractive index higher than or equal to the third value and lower than or equal to the fourth value and including titanium niobium oxide; a ninth functional layer disposed on the eighth functional layer and having a refractive index higher than or equal to the first value and lower than or equal to the second value and including silicon aluminum oxide; a tenth functional layer disposed on the ninth functional layer and having a refractive index higher than or equal to the third value and lower than or equal to the fourth value and including titanium niobium oxide; an eleventh functional layer disposed on the tenth functional layer and having a refractive index higher than or equal to the first value and lower than or equal to the second value and including silicon aluminum oxide; a twelfth functional layer disposed on the tenth functional layer and having a refractive index higher than or equal to the third value and lower than or equal to the fourth value and including titanium niobium oxide; a thirteenth functional layer disposed on the twelfth functional layer and having a refractive index higher than or equal to the first value and lower than or equal to the second value and including silicon aluminum oxide; a fourteenth functional layer disposed on the thirteenth functional layer and having a refractive index higher than or equal to the third value and lower than or equal to the fourth value and including titanium niobium oxide; a fifteenth functional layer disposed on the fourteenth functional layer and having a refractive index higher than or equal to the first value and lower than or equal to the second value and including silicon aluminum oxide; a sixteenth functional layer disposed on the fifteenth functional layer and having a refractive index higher than or equal to the third value and lower than or equal to the fourth value and including titanium niobium oxide; a seventeenth functional layer disposed on the sixteenth functional layer and having a refractive index higher than or equal to the first value and lower than or equal to the second value and including silicon aluminum oxide; an eighteenth functional layer disposed on the seventeenth functional layer and having a refractive index higher than or equal to the third value and lower than or equal to the fourth value and including titanium niobium oxide; and a nineteenth functional layer disposed on the eighteenth functional layer and having a refractive index higher than or equal to the first value and lower than or equal to the second value and including silicon aluminum oxide.

A lens module in accordance with an embodiment of the present disclosure may include a base member, a first hard coating layer, a filter, a first water-repellent layer, a second hard coating layer, a light absorption layer and a second water-repellent layer. The base member may allow at least a portion of incident light to transmit. The first hard coating layer may be disposed on the base member and include tungsten oxide or chrome oxide. The filter may be disposed on the first hard coating layer and have a light transmissivity of 10% or lower for wavelengths of 555 nm or greater and 565 nm or smaller of the incident light. The first water-repellent layer may be disposed on the filter and include a hydrophobic material. The second hard coating layer may be disposed underneath the base member and include tungsten oxide or chrome oxide. The light absorption layer may be disposed underneath the second hard coating layer, absorb at least a portion of the incident light and include silicon dioxide and zirconium oxide. The second water-repellent layer may be disposed underneath the light absorption layer and include a hydrophobic material.

In an embodiment of the present disclosure, wherein the base member may include synthetic resin or glass.

In an embodiment of the present disclosure, the filter may include a plurality of low refractive index layers and a plurality of high refractive index layers. Each of the plurality of low refractive index layers may include silicon aluminum oxide. Each of the high refractive index layers may have a higher refractive index than a refractive index of each of the plurality of low refractive index layers, include titanium oxide and be disposed alternately with each of the low refractive index layers.

In an embodiment of the present disclosure, the filter may include: a first functional layer disposed on the base member and having a refractive index higher than or equal to a first value and lower than or equal to a second value and including silicon aluminum oxide; a second functional layer disposed on the first functional layer and having a refractive index higher than or equal to a third value and lower than or equal to a fourth value and including titanium niobium oxide, the third value being greater than the second value; a third functional layer disposed on the second functional layer and having a refractive index higher than or equal to the first value and lower than or equal to the second value and including silicon aluminum oxide; a fourth functional layer disposed on the third functional layer and having a refractive index higher than or equal to the third value and lower than or equal to the fourth value and including titanium niobium oxide; a fifth functional layer disposed on the fourth functional layer and having a refractive index higher than or equal to the first value and lower than or equal to the second value and including silicon aluminum oxide; a sixth functional layer disposed on the fifth functional layer and having a refractive index higher than or equal to the third value and lower than or equal to the fourth value and including titanium niobium oxide; a seventh functional layer disposed on the sixth functional layer and having a refractive index higher than or equal to the first value and lower than or equal to the second value and including silicon aluminum oxide; an eighth functional layer disposed on the seventh functional layer and having a refractive index higher than or equal to the third value and lower than or equal to the fourth value and including titanium niobium oxide; a ninth functional layer disposed on the eighth functional layer and having a refractive index higher than or equal to the first value and lower than or equal to the second value and including silicon aluminum oxide; a tenth functional layer disposed on the ninth functional layer and having a refractive index higher than or equal to the third value and lower than or equal to the fourth value and including titanium niobium oxide; an eleventh functional layer disposed on the tenth functional layer and having a refractive index higher than or equal to the first value and lower than or equal to the second value and including silicon aluminum oxide; a twelfth functional layer disposed on the tenth functional layer and having a refractive index higher than or equal to the third value and lower than or equal to the fourth value and including titanium niobium oxide; a thirteenth functional layer disposed on the twelfth functional layer and having a refractive index higher than or equal to the first value and lower than or equal to the second value and including silicon aluminum oxide; a fourteenth functional layer disposed on the thirteenth functional layer and having a refractive index higher than or equal to the third value and lower than or equal to the fourth value and including titanium niobium oxide; a fifteenth functional layer disposed on the fourteenth functional layer and having a refractive index higher than or equal to the first value and lower than or equal to the second value and including silicon aluminum oxide; a sixteenth functional layer disposed on the fifteenth functional layer and having a refractive index higher than or equal to the third value and lower than or equal to the fourth value and including titanium niobium oxide; a seventeenth functional layer disposed on the sixteenth functional layer and having a refractive index higher than or equal to the first value and lower than or equal to the second value and including silicon aluminum oxide; an eighteenth functional layer disposed on the seventeenth functional layer and having a refractive index higher than or equal to the third value and lower than or equal to the fourth value and including titanium niobium oxide; and a nineteenth functional layer disposed on the eighteenth functional layer and having a refractive index higher than or equal to the first value and lower than or equal to the second value and including silicon aluminum oxide.

A glasses module in accordance with the present disclosure may include a lens module and a frame. The frame may include a first sub-frame coupled with the lens module and a second sub-frame including a first support coupled with the first sub-frame and a second support that may be extended to the first support and make contact with an ear of a user. The lens module may include a base member, a first hard coating layer, a filter, a first water-repellent layer, a second hard coating layer, a light absorption layer and a second water-repellent layer. The base member may allow at least a portion of incident light to transmit and may dyed by a dye material. The first hard coating layer may be spaced further apart from the second support than the base member is and include silicon dioxide. The filter may be spaced further apart from the second support than the first hard coating layer is and have a light transmissivity of 10% or lower for wavelengths of 555 nm or greater and 565 nm or smaller of the incident light. The first water-repellent layer may be spaced further apart from the second support than the filter is and include a hydrophobic material. The second hard coating layer may be disposed closer to the second support than the base member is and include silicon dioxide. The light absorption layer may be disposed closer to the second support than the second hard coating layer is, absorb at least a portion of the incident light and include silicon dioxide and zirconium oxide. The second water-repellent layer may disposed closer to the second support than the light absorption layer is and include a hydrophobic material.

In an embodiment of the present disclosure, the base member may include synthetic resin.

In an embodiment of the present disclosure, the filter may include a plurality of low refractive index layers and a plurality of high refractive index layers. Each of the plurality of low refractive index layers may include silicon aluminum oxide. Each of the high refractive index layers may have a higher refractive index than a refractive index of each of the plurality of low refractive index layers, include titanium oxide and be disposed alternately with each of the low refractive index layers.

In an embodiment of the present disclosure, the filter may include a plurality of low refractive index layers and a plurality of high refractive index layers. Each of the plurality of low refractive index layers may include silicon aluminum oxide. Each of the high refractive index layers may have a higher refractive index than a refractive index of each of the plurality of low refractive index layers, include titanium oxide and be disposed alternately with each of the low refractive index layers.

A glasses module in accordance with the present disclosure may include a lens module and a frame. The frame may include a first sub-frame coupled with the lens module and a second sub-frame including a first support coupled with the first sub-frame and a second support that may be extended to the first support and make contact with an ear of a user. The lens module may include a base member, a first hard coating layer, a filter, a first water-repellent layer, a second hard coating layer, a light absorption layer and a second water-repellent layer. The base member may allow at least a portion of incident light to transmit. The first hard coating layer may be spaced further apart from the second support than the base member is and include tungsten oxide or chrome oxide. The filter may be spaced further apart from the second support than the first hard coating layer is and have a light transmissivity of 10% or lower for wavelengths of 555 nm or greater and 565 nm or smaller of the incident light. The first water-repellent layer may be spaced further apart from the second support than the filter is and include a hydrophobic material. The second hard coating layer may be disposed closer to the second support than the base member is and include tungsten oxide or chrome oxide. The light absorption layer may be disposed closer to the second support than the second hard coating layer is, absorb at least a portion of the incident light and include silicon dioxide and zirconium oxide. The second water-repellent layer may be disposed closer to the second support than the light absorption layer is and include a hydrophobic material.

An embodiment of the present disclosure may allow a glasses wearer to clearly distinguish color red and color green, thereby reducing the inconvenience caused by red-green color amblyopia.

An embodiment of the present disclosure may also allow a person wearing the glasses for compensating for red-green color amblyopia to experience less inconvenience caused by the light incident from the back of the glasses wearer.

### BRIEF DESCRIPTION OF THE DRAWINGS

FIG. 1 illustrates an example of a glasses module in accordance with an embodiment of the present disclosure.

FIG. 2 illustrates an example of a section of the embodiment shown in FIG. 1 along the line indicated by I-I′.

FIG. 3 illustrates an example of a stacking structure of a filter shown in FIG. 2.

FIG. 4 is a graph illustrating the light transmissivity of a lens module shown in FIG. 2.

FIG. 5 illustrates an example of a section of the embodiment shown in FIG. 1 along the line indicated by I-I′.

### DETAILED DESCRIPTION

Hereinafter, certain embodiments of the present disclosure will be described with reference to the appended drawings.

In the drawings appended hereto, the scales and dimensions of certain elements have been exaggerated for the purpose of description and understanding. Any description including “and/or” should be understood to encompass one or more combinations that are definable by the elements associated with “and/or.”

Terms such as “include” are intended to designate the presence of certain features, numbers, steps, operations, elements, components or any combinations thereof and shall not be understood to preclude the presence or addition of one or more other features, numbers, steps, operations, elements, components or any combinations thereof.

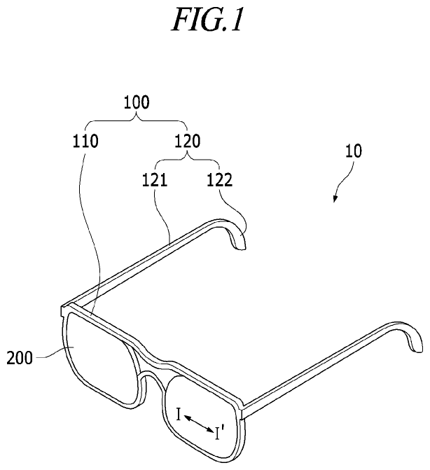

FIG. 1 illustrates an example of a glasses module 10 in accordance with an embodiment of the present invention.

The glasses module 10 may include a frame 100 and a lens module 200.

The frame 100 is configured to fix the lens module 200 thereto and to be in direct contact with the face of a user. In an embodiment of the present invention, the frame 100 may be understood to be a glasses frame.

The frame 100 may include a first sub-frame 110 and a second sub-frame 120.

The first sub-frame 110 may be coupled with the lens module 200. The first sub-frame 110 may surround at least a portion of the lens module 200.

The second sub-frame 120 may include a first support 121 and a second support 122.

The first support 121 may be coupled with the first sub-frame 110. Although not shown explicitly, the first support 121 may be hinge-coupled with the first sub-frame 110.

The second support 122 may be extended from the first support 121. The second support 122 may make contact with an ear of the user to allow the glasses module 10 to be fixed to the face of the user.

The lens module 200 is configured to allow some of the light incident from an outside to transmit to provide the light to the user.

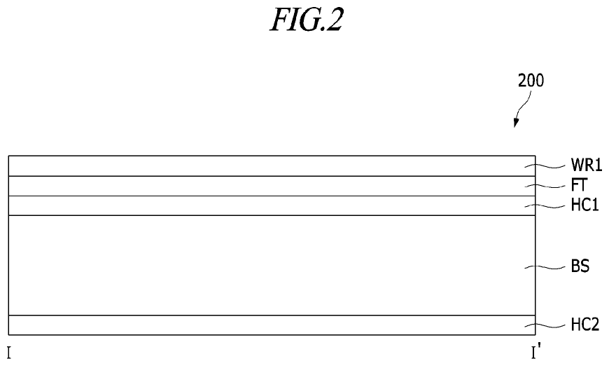

FIG. 2 illustrates an example of a section of the embodiment shown in FIG. 1 along the line indicated by I-I′.

Referring to FIG. 2, the lens module 200 may include a base member BS, a first hard coating layer HC1, a filter FT, a first water-repellent layer WR1, a second hard coating layer HC2, a light absorption layer AR and a second water-repellent layer WR2.

The base member BS may include a transparent material. In an embodiment of the present disclosure, the transparent material may be, but not limited to, a synthetic resin (or plastic). In another embodiment of the present disclosure, the transparent material may be glass. In an embodiment of the present disclosure, the base member BS may be dyed by a dye material to have a predetermined color.

The first hard coating layer HC1 may be disposed on the base member BS. A space between the first hard coating layer HC1 and the second support 122 may be greater than a space between the base member BS and the second support 122. That is, the first hard coating layer HC1 may be spaced further apart from the second support 122 than the base member BS is.

The first hard coating layer HC1 may prevent the base member BS from being damaged. In an embodiment of the present disclosure, the first hard coating layer HC1 may include silicon dioxide (SiO₂).

The filter FT may be disposed on the first hard coating layer HC1. A space between the filter FT and the second support 122 may be greater than a space between the first hard coating layer HC1 and the second support 122. That is, the filter FT may be spaced further apart from the second support 122 than the first hard coating layer HC1 is.

The filter FT may block light having specific wavelengths in the incident light from being transmitted. In an embodiment of the present disclosure, the filter FT may have a light transmissivity of 10% or lower for wavelengths between 555 nm and 565 nm of the incident light. Preferably, the filter FT may have the light transmissivity of 0.1% or lower for wavelengths between 555 nm and 565 nm of the incident light. That is, the filter FT may have a reflectivity of 99.9% or higher for wavelengths between 555 nm and 565 nm of the incident light.

As the filter FT does not allow the wavelengths between 555 nm and 565 nm of the incident light to be transmitted, the user wearing the glasses module 10 may distinguish and visually recognize the colors of red and green more clearly.

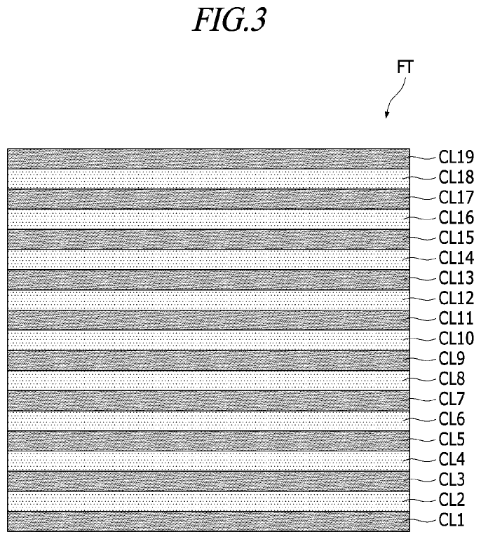

The stacking structure of the filter FT having the above-described functionality will be described in more detail with reference to FIG. 3.

The first water-repellent layer WR1 may be disposed on the filter FT. A space between the first water-repellent layer WR1 and the second support 122 may be greater than a space between the filter FT and the second support 122. That is, the first water-repellent layer WR1 may be spaced further apart from the second support 122 than the filter FT is.

The first water-repellent layer WR1 may prevent, for example, water droplets from forming on a surface of the lens module 200. Moreover, the first water-repellent layer WR1 may prevent, for example, stains caused by the user's fingerprints from forming on the surface of the lens module 200. In an embodiment of the present disclosure, the first water-repellent layer WR1 may include a hydrophobic material. The hydrophobic material may include fluorine.

The second hard coating layer HC2 may be disposed underneath the base member BS. A space between the second hard coating layer HC2 and the second support 122 may be smaller than a space between the base member BS and the second support 122. That is, the second hard coating layer HC2 may be disposed closer to the second support 122 than the base member BS is.

The second hard coating layer HC2 may prevent the base member BS from being damaged. In an embodiment of the present disclosure, the second hard coating layer HC2 may include silicon dioxide (SiO₂).

The light absorption layer AR may be disposed underneath the second hard coating layer HC2. A space between the light absorption layer AR and the second support 122 may be smaller than a space between the second hard coating layer HC2 and the second support 122. That is, the light absorption layer AR may be disposed closer to the second support 122 than the second hard coating layer HC2 is.

The light absorption layer AR may absorb at least a portion of the incident light. In an embodiment of the present disclosure, the light absorption layer AR may include silicon dioxide (SiO₂) and zirconium oxide.

Specifically, the light incident from underneath the lens module 200 (i.e., the light incident from the back of the user wearing the glasses module 10) passes through the second water-repellent layer WR2 before being absorbed by the light absorption layer AR. The light having passed through the light absorption layer AR successively passes through the second hard coating layer HC2, the base member BS and the first hard coating layer HC1 before reaching the filter FT. Since the filter FT has the reflectivity of 99.9% or higher for the light having wavelengths between 555 nm and 565 nm, the light reflected by the filter FT passes through the first hard coating layer HC1, the base member BS and the second hard coating layer HC2 successively before reaching the light absorption layer AR. As some of the reflected light is absorbed by the light absorption layer AR, the user wearing the glasses module 10 does hardly recognize the light being incident from the back of the user. That is, the light absorption layer AR may function to prevent the light being incident from the back of the user from being visible in the user's field of view.

The second water-repellent layer WR2 may be disposed underneath the light absorption layer AR. A space between the second water-repellent layer WR2 and the second support 122 may be smaller than a space between the light absorption layer AR and the second support 122. That is, the second water-repellent layer WR2 may be disposed closer to the second support 122 than the light absorption layer AR is.

The second water-repellent layer WR2 may prevent, for example, water droplets from forming on the surface of the lens module 200. Moreover, the second water-repellent layer WR2 may prevent, for example, stains caused by the user's fingerprints from forming on the surface of the lens module 200. In an embodiment of the present disclosure, the second water-repellent layer WR2 may include a hydrophobic material. The hydrophobic material may include fluorine.

FIG. 3 illustrates an example of a stacking structure of the filter FT shown in FIG. 2.

The filter FT may include a plurality of functional layers CL1-CL19. In an embodiment of the present disclosure, each of the functional layers CL1-CL19 may include low refractive index layers having refractive indices between a first value and a second value and high refractive index layers having refractive indices between a third value, which is greater than the second value, and a fourth value. For instance, the refractive index for each of the low refractive index layers may be higher than or equal to 1.4 and lower than or equal to 1.6, and the refractive index for each of the high refractive index layers may be higher than or equal to 2.3 and lower than or equal to 2.4. In such a case, the first value may be 1.4, and the second value may be 1.6, and the third value may be 2.3, and the fourth value may be 2.4.

In an embodiment of the present disclosure, the low refractive index layers and the high refractive index layers may be alternately arranged. In an embodiment of the present disclosure, the number of the low refractive index layers may be greater than the number of the high refractive index layers.

A first functional layer CL1 may be disposed on the base member BS. The first functional layer CL1 may be a low refractive index layer having a refractive index higher than or equal to the first value and lower than or equal to the second value and may include silicon aluminum oxide (SiₓAlₓOₓ).

The second functional layer CL2 may be disposed on the first functional layer CL1. The second functional layer CL2 may be a high refractive index layer having a refractive index higher than or equal to the third value, which is greater than the second value, and lower than or equal to the fourth value and may include titanium niobium oxide (TiₓNbₓOₓ).

The third functional layer CL3 may be disposed on the second functional layer CL2. The third functional layer CL3 may be a low refractive index layer having a refractive index higher than or equal to the first value and lower than or equal to the second value and may include silicon aluminum oxide.

The fourth functional layer CL4 may be disposed on the third functional layer CL3. The fourth functional layer CL4 may be a high refractive index layer having a refractive index higher than or equal to the third value and lower than or equal to the fourth value and may include titanium niobium oxide.

The fifth functional layer CL5 may be disposed on the fourth functional layer CL4. The fifth functional layer CL5 may be a low refractive index layer having a refractive index higher than or equal to the first value and lower than or equal to the second value and may include silicon aluminum oxide.

The sixth functional layer CL6 may be disposed on the fifth functional layer CL5. The sixth functional layer CL6 may be a high refractive index layer having a refractive index higher than or equal to the third value and lower than or equal to the fourth value and may include titanium niobium oxide.

The seventh functional layer CL7 may be disposed on the sixth functional layer CL6. The seventh functional layer CL7 may be a low refractive index layer having a refractive index higher than or equal to the first value and lower than or equal to the second value and may include silicon aluminum oxide.

The eighth functional layer CL8 may be disposed on the seventh functional layer CL7. The eighth functional layer CL8 may be a high refractive index layer having a refractive index higher than or equal to the third value and lower than or equal to the fourth value and may include titanium niobium oxide.

The ninth functional layer CL9 may be disposed on the eighth functional layer CL8. The ninth functional layer CL9 may be a low refractive index layer having a refractive index higher than or equal to the first value and lower than or equal to the second value and may include silicon aluminum oxide.

The tenth functional layer CL10 may be disposed on the ninth functional layer CL9. The tenth functional layer CL10 may be a high refractive index layer having a refractive index higher than or equal to the third value and lower than or equal to the fourth value and may include titanium niobium oxide.

The eleventh functional layer CL11 may be disposed on the tenth functional layer CL10. The eleventh functional layer CL11 may be a low refractive index layer having a refractive index higher than or equal to the first value and lower than or equal to the second value and may include silicon aluminum oxide.

The twelfth functional layer CL12 may be disposed on the eleventh functional layer CL11. The twelfth functional layer CL12 may be a high refractive index layer having a refractive index higher than or equal to the third value and lower than or equal to the fourth value and may include titanium niobium oxide.

The thirteenth functional layer CL13 may be disposed on the twelfth functional layer CL12. The thirteenth functional layer CL13 may be a low refractive index layer having a refractive index higher than or equal to the first value and lower than or equal to the second value and may include silicon aluminum oxide.

The fourteenth functional layer CL14 may be disposed on the thirteenth functional layer CL13. The fourteenth functional layer CL14 may be a high refractive index layer having a refractive index higher than or equal to the third value and lower than or equal to the fourth value and may include titanium niobium oxide.

The fifteenth functional layer CL15 may be disposed on the fourteenth functional layer CL14. The fifteenth functional layer CL15 may be a low refractive index layer having a refractive index higher than or equal to the first value and lower than or equal to the second value and may include silicon aluminum oxide.

The sixteenth functional layer CL16 may be disposed on the fifteenth functional layer CL15. The sixteenth functional layer CL16 may be a high refractive index layer having a refractive index higher than or equal to the third value and lower than or equal to the fourth value and may include titanium niobium oxide.

The seventeenth functional layer CL17 may be disposed on the sixteenth functional layer CL16. The seventeenth functional layer CL17 may be a low refractive index layer having a refractive index higher than or equal to the first value and lower than or equal to the second value and may include silicon aluminum oxide.

The eighteenth functional layer CL18 may be disposed on the seventeenth functional layer CL17. The eighteenth functional layer CL18 may be a high refractive index layer having a refractive index higher than or equal to the third value and lower than or equal to the fourth value and may include titanium niobium oxide.

The nineteenth functional layer CL19 may be disposed on the eighteenth functional layer CL18. The nineteenth functional layer CL19 may be a low refractive index layer having a refractive index higher than or equal to the first value and lower than or equal to the second value and may include silicon aluminum oxide.

In another embodiment of the present disclosure, the titanium niobium oxide may be substituted by titanium oxide.

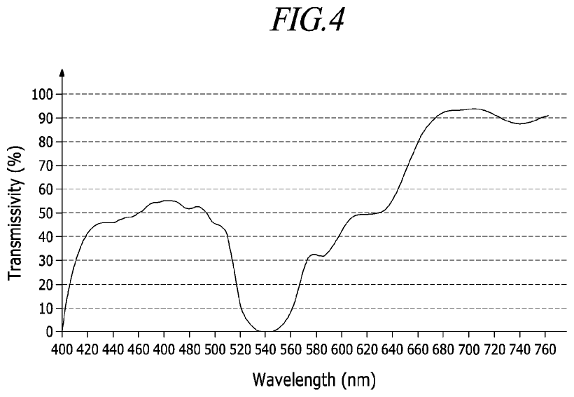

FIG. 4 is a graph illustrating the light transmissivity of the lens module 200 shown in FIG. 2.

Table 1 shown below lists the light transmissivity of the lens module 200 measured by providing light to the lens module 200 illustrated in FIG. 2 and FIG. 3.

TABLE 1

| Wavelength (nm) | Transmissivity (%) |
|---|---|
| 280 | 0.01 |
| 285 | 0.01 |
| 290 | 0.01 |
| 295 | 0.01 |
| 300 | 0.01 |
| 305 | 0.01 |
| 310 | 0.01 |
| 315 | 0.01 |
| 320 | 0.01 |
| 325 | 0.01 |
| 330 | 0.01 |
| 335 | 0.01 |
| 340 | 0.01 |
| 345 | 0.01 |
| 350 | 0.01 |
| 355 | 0.01 |
| 360 | 0.01 |
| 365 | 0.01 |
| 370 | 0.01 |
| 375 | 0.01 |
| 380 | 0.01 |
| 385 | 0.01 |
| 390 | 0.01 |
| 395 | 0.01 |
| 400 | 0.2461 |
| 405 | 14.4314 |
| 410 | 27.6056 |
| 415 | 35.3606 |
| 420 | 40.9851 |
| 425 | 43.8122 |
| 430 | 45.1359 |
| 435 | 45.329 |
| 440 | 45.5914 |
| 445 | 46.485 |
| 450 | 47.4859 |
| 455 | 48.272 |
| 460 | 49.6861 |
| 465 | 51.8587 |
| 470 | 53.6902 |
| 475 | 54.2603 |
| 480 | 54.494 |
| 485 | 54.7938 |
| 490 | 54.1049 |
| 495 | 52.4707 |
| 500 | 51.6869 |
| 505 | 52.2004 |
| 510 | 51.2383 |
| 515 | 48.2497 |
| 520 | 45.0507 |
| 525 | 43.9362 |
| 530 | 39.4412 |
| 535 | 24.6867 |
| 540 | 11.0492 |
| 545 | 4.4263 |
| 550 | 1.4359 |
| 555 | 0.0193 |
| 560 | 0.01 |
| 565 | 0.0356 |
| 570 | 1.3932 |
| 575 | 4.2796 |
| 580 | 9.2017 |
| 585 | 17.1424 |
| 590 | 27.0098 |
| 595 | 32.0873 |
| 600 | 31.7701 |
| 605 | 31.6787 |
| 610 | 34.1284 |
| 615 | 38.1706 |
| 620 | 42.732 |
| 625 | 46.5078 |
| 630 | 48.3579 |
| 635 | 48.9043 |
| 640 | 49.0796 |
| 645 | 49.3914 |
| 650 | 50.1721 |
| 655 | 52.2763 |
| 660 | 56.1808 |
| 665 | 61.7037 |
| 670 | 68.3923 |
| 675 | 74.5854 |
| 680 | 79.7861 |
| 685 | 84.3455 |
| 690 | 88.0221 |
| 695 | 90.4375 |
| 700 | 91.817 |
| 705 | 92.4662 |
| 710 | 92.7836 |
| 715 | 93.0191 |
| 720 | 93.1825 |
| 725 | 93.1474 |
| 730 | 92.7161 |
| 735 | 91.7684 |
| 740 | 90.5285 |
| 745 | 89.2736 |
| 750 | 88.1413 |
| 755 | 87.3178 |
| 760 | 87.0581 |
| 765 | 87.4328 |
| 770 | 88.3443 |
| 775 | 89.3929 |
| 780 | 90.315 |

Referring to Table 1 above and FIG. 4, the lens module 200 including the filter FT illustrated in FIG. 3 has the light transmissivity of about 0.0193 for light having the wavelength of 555 nm, the light transmissivity of about 0.01 for light having the wavelength of 560 nm, and the light transmissivity of about 0.0356 for light having the wavelength of 565 nm. That is, the lens module 200 in accordance with an embodiment of the present disclosure may have a very low light transmissivity of 0.1% or less for wavelengths of 555 nm or greater and 565 nm or less. This very low light transmissivity for the wavelengths of 555 nm or greater and 565 nm or less may be owing to silicon aluminum oxide and titanium niobium oxide included in the filter FT. In the light, the wavelength between about 380 nm and 425 contributes to violet in color, the wavelength between 425 nm and 450 nm to indigo, the wavelength between 450 nm and 495 nm to blue, the wavelength between 495 nm and 570 nm to green, the wavelength between 570 nm and 590 nm to yellow, the wavelength between 590 nm and 620 nm to orange, the wavelength between 620 nm and 780 nm to red. In other words, the light of about 580 nm to 780 nm of wavelength is reddish color, and the light of about 495 nm to 580 nm is greenish color, and the light of about 380 nm to 495 nm of wavelength is bluish color.

As red-green color amblyopia is a deficiency in distinguishing greenish color and reddish color, a red-green color amblyopic person wearing the glasses module 10 may readily distinguish color green and color red when the lens module 200 of the glasses module 10 preponderantly reflects the light having wavelengths between 555 nm and 565 nm that are between green and red.

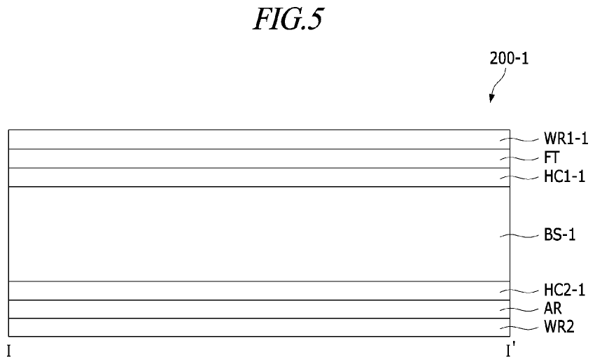

FIG. 5 illustrates an example of a section of the embodiment shown in FIG. 1 along the line indicated by I-I′.

Referring to FIG. 5, a lens module 200-1 may include a base member BS-1, a first hard coating layer HC1-1, the filter FT, the first water-repellent layer WR1, a second hard coating layer HC2-1, the light absorption layer AR and the second water-repellent layer WR2.

The base member BS-1 is not dyed by a dye material, unlike the base member BS shown in FIG. 2.

Each of the first hard coating layer HC1-1 and the second hard coating layer HC2-1 includes tungsten oxide or chrome oxide, and thereby the first hard coating layer HC1-1 and the second hard coating layer HC2-1 may each have a predetermined color. That is, even though the base member BS-1 is not dyed by a dye material, the lens module 200-1 may still have a predetermined color, owing to the color exhibited by each of the first hard coating layer HC1-1 and the second hard coating layer HC2-1.

Other elements of the lens module 200-1 are identical with the elements of the lens module 200 described above and thus will not be described redundantly.

While certain embodiments of the present disclosure have been described, anyone of ordinary skill in the art to which the present disclosure pertains would appreciate that various modifications or permutations to the present disclosure may be available without departing from the technical ideas and scope of the present disclosure described in the appended claims. Moreover, it should be appreciated that the embodiments described in the present disclosure are not intended to limit the technical ideas of the present disclosure thereto and that the claims appended below and every other technical idea within the equivalent claim scope are included in the scope of protection of the present disclosure.

### INDUSTRIAL APPLICABILITY

The present disclosure is directed to a lens module and a glasses module for people with a color deficiency. Considering that about 6% of the world population has a color deficiency, the present disclosure is industrially applicable.

What is claimed is:

1. A lens module comprising:
a base member configured to allow at least a portion of incident light to transmit and dyed by a dye material;
a first hard coating layer disposed on the base member and comprising silicon dioxide;
a filter disposed on the first hard coating layer and having a light transmissivity of 10% or lower for wavelengths of 555 nm or greater and 565 nm or smaller of the incident light;
a first water-repellent layer disposed on the filter and comprising a hydrophobic material;
a second hard coating layer disposed underneath the base member and comprising silicon dioxide;
a light absorption layer disposed underneath the second hard coating layer and configured to absorb at least a portion of the incident light and comprising silicon dioxide and zirconium oxide; and
a second water-repellent layer disposed underneath the light absorption layer and comprising a hydrophobic material.

2. The lens module as set forth in claim 1, wherein the base member comprises synthetic resin.

3. The lens module as set forth in claim 1, wherein the filter comprises:
a plurality of low refractive index layers, each of the plurality of low refractive index layers comprising silicon aluminum oxide; and
a plurality of high refractive index layers, each of the high refractive index layers having a higher refractive index than a refractive index of each of the plurality of low refractive index layers and comprising titanium oxide and disposed alternately with each of the low refractive index layers.

4. The lens module as set forth in claim 3, wherein the number of the plurality of low refractive index layers is greater than the number of the plurality of high refractive index layers.

5. The lens module as set forth in claim 1, wherein the filter comprises:
a first functional layer disposed on the base member and having a refractive index higher than or equal to a first value and lower than or equal to a second value and comprising silicon aluminum oxide;
a second functional layer disposed on the first functional layer and having a refractive index higher than or equal to a third value and lower than or equal to a fourth value and comprising titanium niobium oxide, the third value being greater than the second value;
a third functional layer disposed on the second functional layer and having a refractive index higher than or equal to the first value and lower than or equal to the second value and comprising silicon aluminum oxide;
a fourth functional layer disposed on the third functional layer and having a refractive index higher than or equal to the third value and lower than or equal to the fourth value and comprising titanium niobium oxide;
a fifth functional layer disposed on the fourth functional layer and having a refractive index higher than or equal to the first value and lower than or equal to the second value and comprising silicon aluminum oxide;
a sixth functional layer disposed on the fifth functional layer and having a refractive index higher than or equal to the third value and lower than or equal to the fourth value and comprising titanium niobium oxide;
a seventh functional layer disposed on the sixth functional layer and having a refractive index higher than or equal to the first value and lower than or equal to the second value and comprising silicon aluminum oxide;
an eighth functional layer disposed on the seventh functional layer and having a refractive index higher than or equal to the third value and lower than or equal to the fourth value and comprising titanium niobium oxide;
a ninth functional layer disposed on the eighth functional layer and having a refractive index higher than or equal to the first value and lower than or equal to the second value and comprising silicon aluminum oxide;
a tenth functional layer disposed on the ninth functional layer and having a refractive index higher than or equal to the third value and lower than or equal to the fourth value and comprising titanium niobium oxide;
an eleventh functional layer disposed on the tenth functional layer and having a refractive index higher than or equal to the first value and lower than or equal to the second value and comprising silicon aluminum oxide;
a twelfth functional layer disposed on the tenth functional layer and having a refractive index higher than or equal to the third value and lower than or equal to the fourth value and comprising titanium niobium oxide;
a thirteenth functional layer disposed on the twelfth functional layer and having a refractive index higher than or equal to the first value and lower than or equal to the second value and comprising silicon aluminum oxide;
a fourteenth functional layer disposed on the thirteenth functional layer and having a refractive index higher than or equal to the third value and lower than or equal to the fourth value and comprising titanium niobium oxide;
a fifteenth functional layer disposed on the fourteenth functional layer and having a refractive index higher than or equal to the first value and lower than or equal to the second value and comprising silicon aluminum oxide;
a sixteenth functional layer disposed on the fifteenth functional layer and having a refractive index higher than or equal to the third value and lower than or equal to the fourth value and comprising titanium niobium oxide;
a seventeenth functional layer disposed on the sixteenth functional layer and having a refractive index higher than or equal to the first value and lower than or equal to the second value and comprising silicon aluminum oxide;
an eighteenth functional layer disposed on the seventeenth functional layer and having a refractive index higher than or equal to the third value and lower than or equal to the fourth value and comprising titanium niobium oxide; and
a nineteenth functional layer disposed on the eighteenth functional layer and having a refractive index higher than or equal to the first value and lower than or equal to the second value and comprising silicon aluminum oxide.

6. A lens module comprising:
a base member configured to allow at least a portion of incident light to transmit;
a first hard coating layer disposed on the base member and comprising tungsten oxide or chrome oxide;
a filter disposed on the first hard coating layer and having a light transmissivity of 10% or lower for wavelengths of 555 nm or greater and 565 nm or smaller of the incident light;
a first water-repellent layer disposed on the filter and comprising a hydrophobic material;
a second hard coating layer disposed underneath the base member and comprising tungsten oxide or chrome oxide;
a light absorption layer disposed underneath the second hard coating layer and configured to absorb at least a portion of the incident light and comprising silicon dioxide and zirconium oxide; and
a second water-repellent layer disposed underneath the light absorption layer and comprising a hydrophobic material.

7. The lens module as set forth in claim 6, wherein the base member comprises synthetic resin or glass.

8. The lens module as set forth in claim 7, wherein the filter comprises:
a plurality of low refractive index layers, each of the plurality of low refractive index layers comprising silicon aluminum oxide; and
a plurality of high refractive index layers, each of the high refractive index layers having a higher refractive index than a refractive index of each of the plurality of low refractive index layers and comprising titanium oxide and disposed alternately with each of the low refractive index layers.

9. The lens module as set forth in claim 8, wherein the number of the plurality of low refractive index layers is greater than the number of the plurality of high refractive index layers.

10. The lens module as set forth in claim 6, wherein the filter comprises:
a first functional layer disposed on the base member and having a refractive index higher than or equal to a first value and lower than or equal to a second value and comprising silicon aluminum oxide;
a second functional layer disposed on the first functional layer and having a refractive index higher than or equal to a third value and lower than or equal to a fourth value and comprising titanium niobium oxide, the third value being greater than the second value;
a third functional layer disposed on the second functional layer and having a refractive index higher than or equal to the first value and lower than or equal to the second value and comprising silicon aluminum oxide;
a fourth functional layer disposed on the third functional layer and having a refractive index higher than or equal to the third value and lower than or equal to the fourth value and comprising titanium niobium oxide;
a fifth functional layer disposed on the fourth functional layer and having a refractive index higher than or equal to the first value and lower than or equal to the second value and comprising silicon aluminum oxide;
a sixth functional layer disposed on the fifth functional layer and having a refractive index higher than or equal to the third value and lower than or equal to the fourth value and comprising titanium niobium oxide;
a seventh functional layer disposed on the sixth functional layer and having a refractive index higher than or equal to the first value and lower than or equal to the second value and comprising silicon aluminum oxide;
an eighth functional layer disposed on the seventh functional layer and having a refractive index higher than or equal to the third value and lower than or equal to the fourth value and comprising titanium niobium oxide;
a ninth functional layer disposed on the eighth functional layer and having a refractive index higher than or equal to the first value and lower than or equal to the second value and comprising silicon aluminum oxide;
a tenth functional layer disposed on the ninth functional layer and having a refractive index higher than or equal to the third value and lower than or equal to the fourth value and comprising titanium niobium oxide;
an eleventh functional layer disposed on the tenth functional layer and having a refractive index higher than or equal to the first value and lower than or equal to the second value and comprising silicon aluminum oxide;
a twelfth functional layer disposed on the tenth functional layer and having a refractive index higher than or equal to the third value and lower than or equal to the fourth value and comprising titanium niobium oxide;
a thirteenth functional layer disposed on the twelfth functional layer and having a refractive index higher than or equal to the first value and lower than or equal to the second value and comprising silicon aluminum oxide;
a fourteenth functional layer disposed on the thirteenth functional layer and having a refractive index higher than or equal to the third value and lower than or equal to the fourth value and comprising titanium niobium oxide;
a fifteenth functional layer disposed on the fourteenth functional layer and having a refractive index higher than or equal to the first value and lower than or equal to the second value and comprising silicon aluminum oxide;
a sixteenth functional layer disposed on the fifteenth functional layer and having a refractive index higher than or equal to the third value and lower than or equal to the fourth value and comprising titanium niobium oxide;
a seventeenth functional layer disposed on the sixteenth functional layer and having a refractive index higher than or equal to the first value and lower than or equal to the second value and comprising silicon aluminum oxide;
an eighteenth functional layer disposed on the seventeenth functional layer and having a refractive index higher than or equal to the third value and lower than or equal to the fourth value and comprising titanium niobium oxide; and
a nineteenth functional layer disposed on the eighteenth functional layer and having a refractive index higher than or equal to the first value and lower than or equal to the second value and comprising silicon aluminum oxide.

11. A glasses module comprising:
a lens module; and
a frame,
wherein the frame comprises:
a first sub-frame coupled with the lens module; and
a second sub-frame comprising a first support coupled with the first sub-frame and a second support extended to the first support and configured to make contact with an ear of a user, and
wherein the lens module comprises:
a base member configured to allow at least a portion of incident light to transmit and dyed by a dye material;
a first hard coating layer spaced further apart from the second support than the base member is and comprising silicon dioxide;
a filter spaced further apart from the second support than the first hard coating layer is and having a light transmissivity of 10% or lower for wavelengths of 555 nm or greater and 565 nm or smaller of the incident light;
a first water-repellent layer spaced further apart from the second support than the filter is and comprising a hydrophobic material;
a second hard coating layer disposed closer to the second support than the base member is and comprising silicon dioxide;
a light absorption layer disposed closer to the second support than the second hard coating layer is and configured to absorb at least a portion of the incident light and comprising silicon dioxide and zirconium oxide; and
a second water-repellent layer disposed closer to the second support than the light absorption layer is and comprising a hydrophobic material.

12. The glasses module as set forth in claim 11, wherein the base member comprises synthetic resin.

13. The glasses module as set forth in claim 11, wherein the filter comprises:
a plurality of low refractive index layers, each of the plurality of low refractive index layers comprising silicon aluminum oxide; and
a plurality of high refractive index layers, each of the high refractive index layers having a higher refractive index than a refractive index of each of the plurality of low refractive index layers and comprising titanium oxide and disposed alternately with each of the low refractive index layers.

14. The glasses module as set forth in claim 13, wherein the number of the plurality of low refractive index layers is greater than the number of the plurality of high refractive index layers.

15. The glasses module as set forth in claim 11, wherein the filter comprises:
a first functional layer disposed on the base member and having a refractive index higher than or equal to a first value and lower than or equal to a second value and comprising silicon aluminum oxide;
a second functional layer disposed on the first functional layer and having a refractive index higher than or equal to a third value and lower than or equal to a fourth value and comprising titanium niobium oxide, the third value being greater than the second value;
a third functional layer disposed on the second functional layer and having a refractive index higher than or equal to the first value and lower than or equal to the second value and comprising silicon aluminum oxide;
a fourth functional layer disposed on the third functional layer and having a refractive index higher than or equal to the third value and lower than or equal to the fourth value and comprising titanium niobium oxide;
a fifth functional layer disposed on the fourth functional layer and having a refractive index higher than or equal to the first value and lower than or equal to the second value and comprising silicon aluminum oxide;
a sixth functional layer disposed on the fifth functional layer and having a refractive index higher than or equal to the third value and lower than or equal to the fourth value and comprising titanium niobium oxide;
a seventh functional layer disposed on the sixth functional layer and having a refractive index higher than or equal to the first value and lower than or equal to the second value and comprising silicon aluminum oxide;
an eighth functional layer disposed on the seventh functional layer and having a refractive index higher than or equal to the third value and lower than or equal to the fourth value and comprising titanium niobium oxide;
a ninth functional layer disposed on the eighth functional layer and having a refractive index higher than or equal to the first value and lower than or equal to the second value and comprising silicon aluminum oxide;
a tenth functional layer disposed on the ninth functional layer and having a refractive index higher than or equal to the third value and lower than or equal to the fourth value and comprising titanium niobium oxide;
an eleventh functional layer disposed on the tenth functional layer and having a refractive index higher than or equal to the first value and lower than or equal to the second value and comprising silicon aluminum oxide;
a twelfth functional layer disposed on the tenth functional layer and having a refractive index higher than or equal to the third value and lower than or equal to the fourth value and comprising titanium niobium oxide;
a thirteenth functional layer disposed on the twelfth functional layer and having a refractive index higher than or equal to the first value and lower than or equal to the second value and comprising silicon aluminum oxide;
a fourteenth functional layer disposed on the thirteenth functional layer and having a refractive index higher than or equal to the third value and lower than or equal to the fourth value and comprising titanium niobium oxide;
a fifteenth functional layer disposed on the fourteenth functional layer and having a refractive index higher than or equal to the first value and lower than or equal to the second value and comprising silicon aluminum oxide;
a sixteenth functional layer disposed on the fifteenth functional layer and having a refractive index higher than or equal to the third value and lower than or equal to the fourth value and comprising titanium niobium oxide;
a seventeenth functional layer disposed on the sixteenth functional layer and having a refractive index higher than or equal to the first value and lower than or equal to the second value and comprising silicon aluminum oxide;
an eighteenth functional layer disposed on the seventeenth functional layer and having a refractive index higher than or equal to the third value and lower than or equal to the fourth value and comprising titanium niobium oxide; and
a nineteenth functional layer disposed on the eighteenth functional layer and having a refractive index higher than or equal to the first value and lower than or equal to the second value and comprising silicon aluminum oxide.

16. A glasses module comprising:
a lens module; and
a frame,
wherein the frame comprises:
a first sub-frame coupled with the lens module; and
a second sub-frame comprising a first support coupled with the first sub-frame and a second support extended to the first support and configured to make contact with an ear of a user, and
wherein the lens module comprises:
a base member configured to allow at least a portion of incident light to transmit;
a first hard coating layer spaced further apart from the second support than the base member is and comprising tungsten oxide or chrome oxide;
a filter spaced further apart from the second support than the first hard coating layer is and having a light transmissivity of 10% or lower for wavelengths of 555 nm or greater and 565 nm or smaller of the incident light;
a first water-repellent layer spaced further apart from the second support than the filter is and comprising a hydrophobic material;
a second hard coating layer disposed closer to the second support than the base member is and comprising tungsten oxide or chrome oxide;
a light absorption layer disposed closer to the second support than the second hard coating layer is and configured to absorb at least a portion of the incident light and comprising silicon dioxide and zirconium oxide; and
a second water-repellent layer disposed closer to the second support than the light absorption layer is and comprising a hydrophobic material.

17. The glasses module as set forth in claim 16, wherein the base member comprises synthetic resin or glass.

18. The glasses module as set forth in claim 16, wherein the filter comprises:
a plurality of low refractive index layers, each of the plurality of low refractive index layers comprising silicon aluminum oxide; and
a plurality of high refractive index layers, each of the high refractive index layers having a higher refractive index than a refractive index of each of the plurality of low refractive index layers and comprising titanium oxide and disposed alternately with each of the low refractive index layers.

19. The glasses module as set forth in claim 18, wherein the number of the plurality of low refractive index layers is greater than the number of the plurality of high refractive index layers.

20. The glasses module as set forth in claim 16, wherein the filter comprises:
a first functional layer disposed on the base member and having a refractive index higher than or equal to a first value and lower than or equal to a second value and comprising silicon aluminum oxide;
a second functional layer disposed on the first functional layer and having a refractive index higher than or equal to a third value and lower than or equal to a fourth value and comprising titanium niobium oxide, the third value being greater than the second value;
a third functional layer disposed on the second functional layer and having a refractive index higher than or equal to the first value and lower than or equal to the second value and comprising silicon aluminum oxide;
a fourth functional layer disposed on the third functional layer and having a refractive index higher than or equal to the third value and lower than or equal to the fourth value and comprising titanium niobium oxide;
a fifth functional layer disposed on the fourth functional layer and having a refractive index higher than or equal to the first value and lower than or equal to the second value and comprising silicon aluminum oxide;
a sixth functional layer disposed on the fifth functional layer and having a refractive index higher than or equal to the third value and lower than or equal to the fourth value and comprising titanium niobium oxide;
a seventh functional layer disposed on the sixth functional layer and having a refractive index higher than or equal to the first value and lower than or equal to the second value and comprising silicon aluminum oxide;
an eighth functional layer disposed on the seventh functional layer and having a refractive index higher than or equal to the third value and lower than or equal to the fourth value and comprising titanium niobium oxide;
a ninth functional layer disposed on the eighth functional layer and having a refractive index higher than or equal to the first value and lower than or equal to the second value and comprising silicon aluminum oxide;
a tenth functional layer disposed on the ninth functional layer and having a refractive index higher than or equal to the third value and lower than or equal to the fourth value and comprising titanium niobium oxide;
an eleventh functional layer disposed on the tenth functional layer and having a refractive index higher than or equal to the first value and lower than or equal to the second value and comprising silicon aluminum oxide;
a twelfth functional layer disposed on the tenth functional layer and having a refractive index higher than or equal to the third value and lower than or equal to the fourth value and comprising titanium niobium oxide;
a thirteenth functional layer disposed on the twelfth functional layer and having a refractive index higher than or equal to the first value and lower than or equal to the second value and comprising silicon aluminum oxide;
a fourteenth functional layer disposed on the thirteenth functional layer and having a refractive index higher than or equal to the third value and lower than or equal to the fourth value and comprising titanium niobium oxide;
a fifteenth functional layer disposed on the fourteenth functional layer and having a refractive index higher than or equal to the first value and lower than or equal to the second value and comprising silicon aluminum oxide;
a sixteenth functional layer disposed on the fifteenth functional layer and having a refractive index higher than or equal to the third value and lower than or equal to the fourth value and comprising titanium niobium oxide;
a seventeenth functional layer disposed on the sixteenth functional layer and having a refractive index higher than or equal to the first value and lower than or equal to the second value and comprising silicon aluminum oxide;
an eighteenth functional layer disposed on the seventeenth functional layer and having a refractive index higher than or equal to the third value and lower than or equal to the fourth value and comprising titanium niobium oxide; and
a nineteenth functional layer disposed on the eighteenth functional layer and having a refractive index higher than or equal to the first value and lower than or equal to the second value and comprising silicon aluminum oxide.
